(19) United States
(12) Patent Application Publication
(10) Pub. No.: US 2005/0236069 A1
(43) Pub. Date: Oct. 27, 2005

(54) Adjustable router guide template assembly

(76) Inventor: Vincent E. O'Brien, Greenbrae, CA (US)

Correspondence Address: BEYER WEAVER & THOMAS LLP, P.O. BOX 70250, OAKLAND, CA, 94612-0250, US

(21) Appl. No.: 10/831,718

(22) Filed: Apr. 23, 2004

(51) Int. Cl. B27C 5/00; B27C 1/12; B27C 5/02; B27B 31/00; B27M 1/08; B27M 3/00; B27C 9/00

(52) U.S. Cl. 144/144.1; 144/253.1; 144/144.51

(57) ABSTRACT

An adjustable guide assembly to guide a cutter bit of a tool device about a cutting surface of a workpiece. The guide assembly includes an elongated first guide rail having a first abutting surface adapted to abut a first side wall of the workpiece, and a second guide rail spaced-apart from the first guide rail, and having a second abutting surface adapted to abut a second side wall of the workpiece. A base member is positioned over the first and second guide rails, and includes a tool support surface and an opposed workpiece support surface. The base member includes a contacting wall defining a bit passage therethrough. A first and second interconnection assembly is configured to releasably lock the first and second guide rail, respectively, to the base member in a manner enabling the first guide rail to pivot about a first axis substantially perpendicular to a longitudinal axis of the first guide rail, and the second guide rail to pivot about a second axis substantially perpendicular to a longitudinal axis of the second guide rail, respectively. Further, the first interconnection assembly and the second interconnection assembly enable the first guide rail and the second guide rail to slide along the base member along respective paths adjacent to the bit passage. The first guide rail and the second guide rail are adjusted to abut the workpiece first side wall and the workpiece second side wall in a manner releasably positioning a targeted cutting region of the workpiece cutting surface in the bit passage.

### FIELD OF THE INVENTION

The present invention relates to router guides, and more particularly, relates to router guides with template assemblies to guide a router along predefined cutting paths.

### BACKGROUND OF THE INVENTION

Router devices are often employed for decorative and constructive applications in the woodworking trade. In decorative applications, routers and their corresponding router bits are used for both linear and curvilinear side-cuts, such as dadoes, and for decorative grooves and channels. For constructive applications, the router is applied more or less for straight cuts along lengthwise dimensions and/or widthwide dimensions of a workpiece to fashion ploughs, mortises and/or the two-step routing of tenons and the like. For example, in the construction of wooden ladders, router devices and their corresponding router bits are applied to create mortise cuts in the ladder side supports, they are applied to created tenons cuts in the step portions of the ladder. Subsequently, at mortise and tenon joint, tenons of the step portions are inserted into the mortise cuts of the ladder side supports during construction of wooden step ladders.

Handheld routers, by themselves, are difficult to operate and control. This is especially true when precision operation is necessary, such as for the construction of mortise and tenon joints and dadoes. In these situations, outside of precision robotics, some form of guide or template assembly is employed that is mounted to the workpiece. These guides function to guide the router device about the workpiece cutting surface to facilitate cutting precision. Due to the nature of these applications, however, these router guides and/or templates are typically custom fabricated for a single particular application. Fabrication of the router guide alone, hence, is a time consuming and costly process. Moreover, once the router guide is used, this custom fabrication piece has no other application except to fabricate cuts of the predefined pattern.

Alternatively, templates have been made for repetitive cuts of a standard size and shape, such as for routing recesses for butt-type hinges. These templates are typically good for only one shape of a particular size. If different width or length cuts are needed, another template is needed.

In response, adjustable router guides have been developed that facilitate guided cuts in a workpiece. While these router guides do permit limited adjustment of the size of the guided cuts in the workpiece, the guides themselves are generally significant in size and thus, lack portability. Moreover, these designs are often relative complex devices that contain a significant number of moving components. Consequently, a substantial number of adjustment are required in order to ready the table for router cuts, and the learning curve for operation is relatively steep. This increases both the set-up and operation time, especially when more than one size cut is required in the workpiece. Some of these are good for only one cut and must be reset, in whole or part, if moved for another cut.

Accordingly, a portable router guide template is needed that is simple to operate, easy to adjust, especially when multiple sized cuts are necessary, and retains its settings from cut to cut.

### SUMMARY OF INVENTION

The present invention provides an adjustable guide assembly to guide a cutter bit of a tool device about a cutting surface of a workpiece. The workpiece also includes a first side wall and an opposed second side wall. The tool device, such as a router, includes a support plate providing a guide collar upon which the cutter bit extends therethrough. These collars are commonly referred to as “router guide bushings” and are readily available, e.g. Sears Router Bushing Set, Part #00925083000. The adjustable guide assembly includes an elongated first guide rail having a first abutting surface adapted to abut the first side wall of the workpiece, and a second guide rail spaced-apart from the first guide rail. The second guide rail also includes a second abutting surface adapted to abut the second side wall of the workpiece. The guide assembly includes a base member positioned atop the first and second guide rails, and includes a tool support surface and a workpiece support surface. The base member includes a contacting wall that defines a bit passage which extends from the tool support surface to the workpiece support surface. A first interconnection assembly is provided that is configured to releasably lock the first guide rail to the base member in a manner enabling the first guide rail to pivot about a first axis. This first axis is oriented substantially perpendicular to a longitudinal axis of the first guide rail. The first interconnection assembly further enables the first guide rail to slide along the base member along a path substantially adjacent to the bit passage. Further, a second interconnection assembly is configured to releasably lock the second guide rail to the base member. This second interconnection assembly enables the second guide rail to pivot about a second axis that is similarly substantially perpendicular to a longitudinal axis of the second guide rail. This assembly also enables the second guide rail to slide along the base member along a path substantially adjacent to the bit passage.

During operation, the first guide rail and the second guide rail are adjusted to abut the workpiece first side wall and the workpiece second side wall in a manner releasably positioning a targeted cutting region of the workpiece cutting surface in the bit passage. Once the guide rails are properly positioned, they are secured relative the base member. The adjustable guide assembly is then releasably mounted to the workpiece. Applying the cutting bit in and through the bit passage, the target cut may be formed. The contact walls defining the base member bit passage and the collar of the tool device support plate cooperate to define the perimetric limits of the target cut.

Accordingly, by utilizing the support plate collar and contact wall of the base member to determine the target cut, the present invention can be applied to workpieces having a width much smaller than the diameter of the router base. This is a significant problem with most router guides which utilize the outer circumferential edge of the router base as a contact stop. Moreover, the adjustable guide assembly of the present invention enables a much more efficient set-up and operation to perform standard plough, mortise and tenon cuts. Unlike the current designs, should the length and/or width of the cut require changing, the simple adjustments are performed as opposed to the more complicated setting and resetting of the current router guides.

In one embodiment, the first and second interconnection assembly each include an elongated passage extending along the corresponding path adjacent the bit passage, and fastening pin members configured to releasably lock the respective guide rail to the base member. The pin members are adapted to extend through their respective elongated passage of the base member to enable the pivotal movement of their corresponding guide rails about their rotating axis thereof, as well as the relative sliding movement along the corresponding paths adjacent the bit passage.

Each guide rail further includes an elongated guide slot extending in a direction along its longitudinal axis thereof to enable positioning of the respective pin member, relative of the corresponding guide rail, at one of a plurality of positioned longitudinally therealong.

In yet another configuration, the bit passage is elongated extending generally from one side of the base member to an opposite side thereof. Further, the bit passage is substantially rectangular-shaped. On one side of the bit passage is a first end bushing that is adapted for selective positioning in the bit passage longitudinally therealong. This end bushing is configured to limit movement of the cutter bit of the tool device, by contact with the collar, in one direction longitudinally along the bit passage during the cutting operation. A second end bushing can be positioned on the opposite side the bit passage. Collectively, these two end bushings determine the length of the target cut in the bit passage.

A bushing plate may also be positioned in the bit passage of the base member, as opposed to the end bushings, to further define the shape and size of the target cut. These plates provide predetermined passage shapes that receive the cutting bit therein. In this manner, the bushing plates can be easily interchanged with minimal effort.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawing, in which:

FIG. 1 is a fragmentary, top perspective view of an adjustable guide assembly constructed in accordance with the present invention, and mounted to a workpiece. The router base with collar attached is also shown.

FIG. 2 is a bottom perspective view of the adjustable guide assembly of FIG. 1, and the workpiece after a mortise cut has been performed applying the present invention.

FIG. 3 is a front perspective view of the adjustable guide assembly of FIG. 1.

FIG. 4 is a fragmentary, top perspective view of an alternative embodiment adjustable guide assembly configured for plough cuts.

FIG. 5 is an enlarged, front elevation view, in cross section, of the adjustable guide assembly taken along the plane of the line 5-5 in FIG. 4.

FIG. 6 is a fragmentary, top perspective view of the adjustable guide assembly of FIG. 1 incorporating a template bushing insert.

FIG. 7 is an enlarged, front elevation view of the adjustable guide assembly of the present invention cooperating with a conventional vise clamp that secures the guide rails to the workpiece.

FIG. 8 is a side elevation view of the adjustable guide assembly of the present invention with an integral clamping device that secures the guide rails to the workpiece.

FIG. 9 is a fragmentary, enlarged, side elevation view, in cross section, of the adjustable guide assembly with the integral clamping device taken along the plane of the line 9-9 in FIG. 8.

FIG. 10 is a fragmentary, side elevation view of the adjustable guide assembly of the present invention with an alternative embodiment integral clamping device that secures the guide rails to the workpiece.

FIG. 11 is a fragmentary, enlarged, top plan view, in cross section, of the adjustable guide assembly with the alternative embodiment integral clamping device taken along the plane of the line 11-11 in FIG. 10.

FIG. 12 is a fragmentary, side elevation view of the adjustable guide assembly of the present invention with an alternative embodiment integral clamping device that secures the guide rails to the workpiece.

FIG. 13 is a fragmentary, rear elevation view of the adjustable guide assembly with the alternative embodiment integral clamping device.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

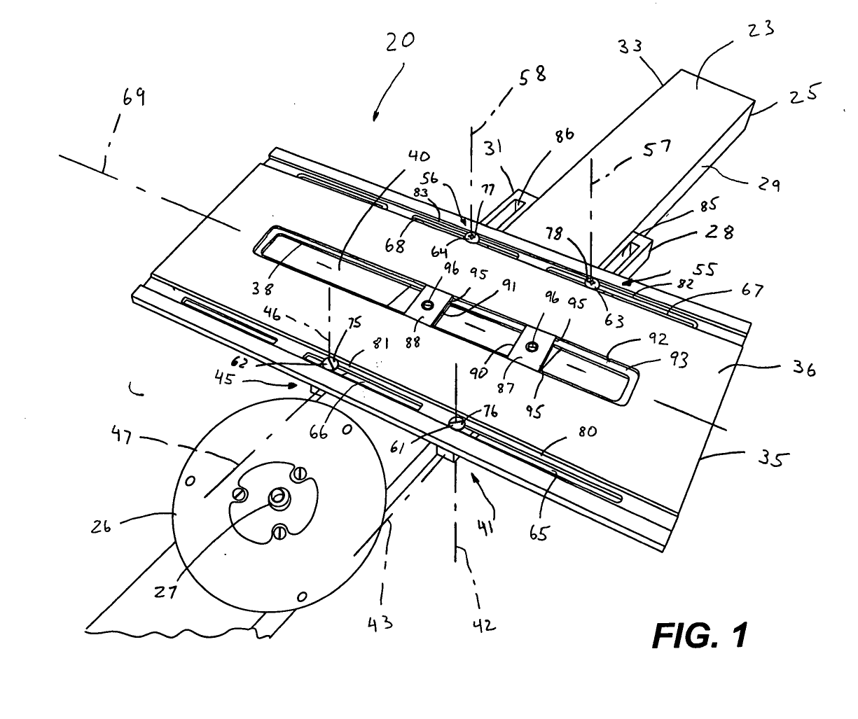

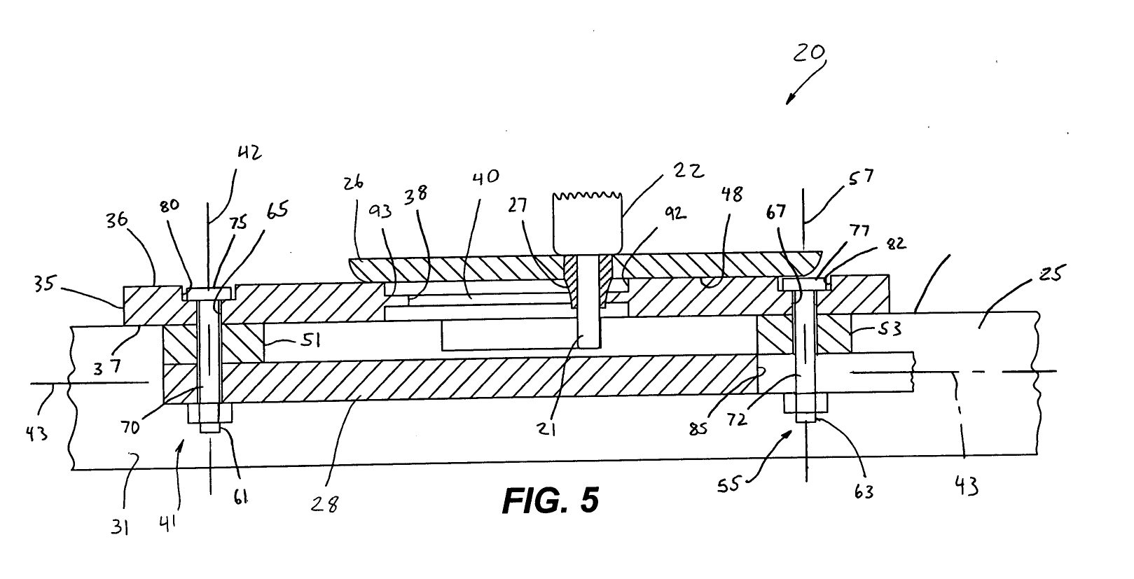

Referring now to FIGS. 1-5, the present invention provides an adjustable guide assembly, generally designated 20, to guide a cutter bit 21 of a tool device 22 (FIG. 5) about a cutting surface 23 of a workpiece 25. The application of the guide assembly 20 is particularly suitable for plough and mortise cuts, but may also be employed to fabricate dados and rabbet, etc. In this instance, the tool device 22 is preferably a handheld powered router that includes a support plate 26 having a central guide collar 27 upon which the cutter bit 21 extends therethrough. It will be appreciated, however, that the present invention may also be applied to other cutting devices employing rotary cutters, such as dremels and hand drills, etc. Further, while the guide assembly of the present invention may be used on workpieces 25 having non-linear, and non-parallel sides, the application is most suited for rectangular workpieces having a planar cutting surface 23.

In accordance with the present invention, the adjustable guide assembly 20 includes an elongated first guide rail 28 having a first abutting surface 30 adapted to abut and seat against a first side wall 29 of the workpiece 25. Similarly, a second guide rail 31 is provided that is spaced-apart from the first guide rail 28. As will be apparent, the distance and relative orientation of this spacing is completely adjustable to accommodate a variety of different sized and shaped workpieces. The second guide rail 31 also includes a second abutting surface 32 adapted to abut a second side wall 33 of the workpiece. The guide assembly 20 includes a base member 35 positioned vertically over the first and second guide rails 28, 31 and includes a substantially planar tool support surface 36 and a substantially planar workpiece support surface 37. The base member 35 includes a vertical contact wall 38 that defines a template for a router bit passage 40 that extends from the tool support surface 36 to the workpiece support surface 37. Briefly, the bit passage 40 is the thru hole in the base member that enables the cutting bit of the router 22 therethrough to enable shaping of the target cut.

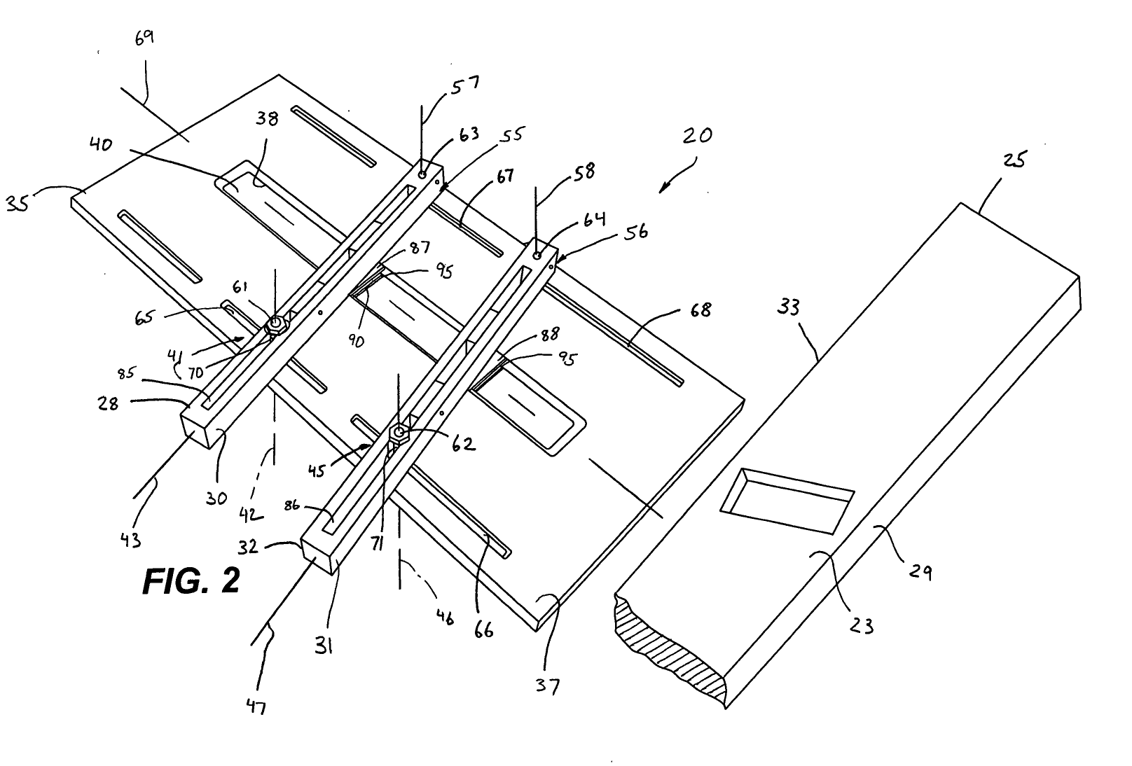

A first interconnection assembly 41 is provided that is configured to releasably lock the first guide rail 28 to the base member 35 in a manner enabling the first guide rail 28 to pivot about a first axis 42. As best viewed in FIGS. 2 and 5, this first axis 42 is oriented substantially perpendicular to a longitudinal axis 43 of the first guide rail 28. Accordingly, the first guide rail is permitted to pivot about the first axis, relative the bit passage 40. The first interconnection assembly 41 further enables the first guide rail to slide along the base member along a path substantially adjacent to the bit passage 40. As will be described in greater detail below, it is this movement versatility that enables the guide assembly to accommodate different sized and shaped workpieces, as well as to reorient a target cutting region relative the cutting surface of the workpiece.

Further, a second interconnection assembly 45 is configured to releasably lock the second guide rail 31 to the base member 35. In a similar manner, this second interconnection assembly 45 enables the second guide rail 31 to pivot about a second axis 46 that is similarly substantially perpendicular to a longitudinal axis 47 of the second guide rail. This interconnection assembly also enables the second guide rail 31 to slide along the base member along a path substantially adjacent to the bit passage 40. Collectively, as will be described, these guide rails function and cooperate to mount the guide assembly to the workpiece, as well as firmly secure to the opposed sides of the workpiece for cutting stability.

During operation, the first guide rail and the second guide rail are adjusted to abut the workpiece first side wall and the workpiece second side wall in a manner positioning the targeted cutting region of the workpiece cutting surface in the bit passage. Once the guide rails are properly positioned and oriented to position the target cutting region in the bit passage, the rails are secured relative the base member. Applying the cutting bit 21 in and through the bit passage 40 as the router support plate 26 slideably contacts the tool support plate 26, the target cut may be formed in the cutting surface of the workpiece. Briefly, using the contact between the guide collar 27 of the tool device support plate 26 and the contact walls 38 defining the base member bit passage 40, the perimetric limits of the target cut are defined.

Accordingly, by utilizing the support plate guide collar 27 and contact wall 38 of the base member 35 to determine the outer parameters of the target cut, as opposed to the perimeter of the router support plate 26, the present invention can be applied to workpieces having a width much smaller than the diameter of the router base. This is a significant problem with most router guides which utilize the outer circumferential edge of the router base as a contact stop. Moreover, the adjustable guide assembly of the present invention is much easier to adjustment and set-up than other devices that enable standard mortise and plough cuts. Unlike the current designs, should multiple cuts of varying length and/or width be required, the guide assembly is simple and easy to adjust as compared to the more complicated setting and resetting of the current router guides.

Referring now to FIGS. 1, 2 and 5, the router guide assembly 20 will be described in greater detail. As mentioned, the present invention guide assembly is particularly suitable for plough and mortise cuts in elongated, rectangular-shaped workpieces 25. By pivoting the guide rails 28, 31 about their respective axes, relative the stationary bit passage 40, angled target cuts can be easily fashioned in the cutting surface 23 of the workpiece 25 positioned in the bit passage 40. The present invention is particularly suitable for fabricating multiple spaced-apart mortise or plough cuts of same sized angled cuts, such as would be required for the side rails of a step ladder or the like. By simply releasing the guide assembly from the workpiece, and then sliding the guide assembly 20, via the base member 35 and guide rails 28, 31 longitudinally along the workpiece 25, identical target cuts can be easily executed. Another application example would include stair, deck and step railings using standard dimension lumber for pickets where the pickets are mortised into the top and bottom railings. Yet another example application would include bookshelves.

The first and second guide rails 28, 31 are preferably elongated, having substantially linear first and second abutting surfaces 30, 32, respectively, that engage the substantially linear side surfaces of conventional workpieces. However, depending upon the shape of the side surfaces of the workpiece, the abutting surfaces 30, 32 of the guide rails 28, 31 can be selected accordingly. For example, the guide rail abutting surfaces can be easily configured to accommodate curvilinear surfaces as well, as long as the guide rails enable stable mounting of the workpiece therebetween.

These guide rails are also preferably composed of a substantially rigid material such as metal, plastic or wood. Such rigidity facilitates gripping and stability relative the base member when the workpiece 25 is mounted between the guide rails. It will be appreciated, however, that the guide rails may be slightly flexible, and/or contain some nominal padding or the like over the abutting surfaces.

The upper tool support surface 36 is preferably substantially planar-shaped, as is the opposed workpiece support surface 37. The planar shape of the tool support surface 36 conforms to the substantially planar contact surface 48 (FIG. 5) of the route support plate 26 of the router 22 that slideably engages the support surface during operation. Similarly, the substantially planar workpiece support surface 37 is configured to accommodate a workpiece 25 with a substantially planar cutting surface 23. Should workpiece have a cutting surface 23 that is non-planar shaped, the workpiece support surface 37 of the base member can be configured and dimensioned accordingly to accommodate such a surface shape for stable mounting support thereof.

The base member is also substantially rigid, and relatively thin since the cutting bit 21 of the router 22 must be of a sufficiently length to extend through bit passage 40 and into the cutting surface of the workpiece by a designated depth. Accordingly, the depth of the target cut may be adjusted either by selecting the thickness of the base member 35, and/or the adjusting length of the extension of the cutter bit from the support plate. An exemplary thickness is preferably in the range of about ⅛ inch to about ½ inch. Suitable rigid materials include metal and plastic.

As mentioned, it is the bit passage 40 determines the shape and size of the target cut, as well as enable the cutter bit 21 to extend through for contact with the workpiece. Once the guide rails 28, 31 and base member 35 of the adjustable guide assembly 20 are displaced and oriented, and secured to the workpiece, as will be described, the cutter bit 21 of the router 22 is positioned through the bit passage 40 and into the target workpiece until the router support plate contact the tool support surface 36. As indicated, based upon the thickness of the base member 35 and the length of the cutter bit, the depth of the target cut will be determined. Moreover, it is a combination of router bits and guide collars 27 of predetermined diameters in conjunction with an interior guide dimension of the passage 40, such that the width of the plough can accommodate standard dimension lumber. By selecting the right combination of base template opening, bushing size and router bit size, a plough, mortise or trough can be quickly made for any standard size lumber. Tables I & II below give the various combinations that will result in a plough, mortise or trough of various widths in increments of 1/16^{th} of an inch.

For example, most of the dimension lumber sold in the U.S. comes in 1″ and 2″ thickness dimensions. These are generally referred to as 1× (one by) and 2× (two by), e.g. a 2×4. The actual thickness of these is ¾″ and 1½″ surface dry. Table I shows that a plough, mortise or trough that will accept a 1× can be produced using a base template with a 1⅛″ wide opening, a ¼″ diameter router bit and a ⅝ bushing. Table II shows that a 1× can be produced by using a base template with a 1⅞″ wide opening, a ¼″ diameter router bit and a 1⅜″ bushing. This same base template can accommodate a 2× by using a ¼″ router bit and a ⅝″ bushing.

Note that the same plough, mortise or trough width can be produced by using different bushing sizes (found by reading across a row). Also, once a template opening and bushing size are selected, ploughs, mortises and troughs of different widths can be produced by selecting different size router bits (found by reading diagonally downward). Likewise, once a template opening and bit have been selected, ploughs, mortises and troughs of different widths can be produced by selecting different size bushings (found by reading down a column).

TABLE I
DETERMING BUSHING SIZE
Template Opening = 1⅛ inches

| | Router Bit Diameter | | | | |
|---|---|---|---|---|---|
| Plough Width | ¼ | 5/16 | ⅜ | 7/16 | ½ |
| ¼ | 1⅛ | | | | |
| 5/16 | 1 1/16 | 1⅛ | | | |
| ⅜ | 1 | 1 1/16 | 1⅛ | | |
| 7/16 | 15/16 | 1 | 1 1/16 | 1⅛ | |
| ½ | ⅞ | 15/16 | 1 | 1 1/16 | 1⅛ |
| 9/16 | 13/16 | ⅞ | 15/16 | 1 | 1 1/16 |
| ⅝ | ¾ | 13/16 | ⅞ | 15/16 | 1 |
| 11/16 | 11/16 | ¾ | 13/16 | ⅞ | 15/16 |
| ¾ | ⅝ | 11/16 | ¾ | 13/16 | ⅞ |
| 13/16 | 9/16 | ⅝ | 11/16 | ¾ | 13/16 |
| ⅞ | ½ | 9/16 | ⅝ | 11/16 | ¾ |
| 15/16 | 7/16 | ½ | 9/16 | ⅝ | 11/16 |
| 1 | ⅜ | 7/16 | ½ | 9/16 | ⅝ |
| 1 1/16 | 5/16 | ⅜ | 7/16 | ½ | 9/16 |
| 1⅛ | ¼ | 5/16 | ⅜ | 7/16 | ½ |
| 1 3/16 | 3/16 | ¼ | 5/16 | ⅜ | 7/16 |

TABLE II
DETERMING BUSHING SIZE
Template Opening = 1⅞ inches

| | Router Bit Diameter | | | | |
|---|---|---|---|---|---|
| Plough Width | ¼ | 5/16 | ⅜ | 7/16 | ½ |
| ¼ | 1⅞ | | | | |
| 5/16 | 1 13/16 | 1⅞ | | | |
| ⅜ | 1¾ | 1 13/16 | 1⅞ | | |
| 7/16 | 1 11/16 | 1¾ | 1 3/16 | 1⅞ | |
| ½ | 1⅝ | 1 11/16 | 1¾ | 1 13/16 | 1⅞ |
| 9/16 | 1 9/16 | 1⅝ | 1 11/16 | 1¾ | 1 13/16 |
| ⅝ | 1½ | 1 9/16 | 1⅝ | 1 11/16 | 1¾ |
| 11/16 | 1 7/16 | 1½ | 1 9/16 | 1⅝ | 1 11/16 |
| ¾ | 1⅜ | 1 7/16 | 1½ | 1 9/16 | 1⅝ |
| 13/16 | 1 5/16 | 1⅜ | 1 7/16 | 1½ | 1 9/16 |
| ⅞ | 1¼ | 1 5/16 | 1⅜ | 1 7/16 | 1½ |
| 15/16 | 1 3/16 | 1¼ | 1 5/16 | 1⅜ | 1 7/16 |
| 1 | 1⅛ | 1 3/16 | 1¼ | 1 5/16 | 1⅜ |
| 1 1/16 | 1 1/16 | 1⅛ | 1 3/16 | 1¼ | 1 5/16 |
| 1⅛ | 1 | 1 1/16 | 1⅛ | 1 3/16 | 1¼ |
| 1 3/16 | 15/16 | 1 | 1 1/16 | 1⅛ | 1 3/16 |
| 1¼ | ⅞ | 15/16 | 1 | 1 1/16 | 1⅛ |
| 1 5/16 | 13/16 | ⅞ | 15/16 | 1 | 1 1/16 |
| 1⅜ | ¾ | 13/16 | ⅞ | 15/16 | 1 |
| 1 7/16 | 11/16 | ¾ | 13/16 | ⅞ | 15/16 |
| 1½ | ⅝ | 11/16 | ¾ | 13/16 | ⅞ |
| 1 9/16 | 9/16 | ⅝ | 11/16 | ¾ | 13/16 |
| 1⅝ | ½ | 9/16 | ⅝ | 11/16 | ¾ |
| 1 11/16 | 7/16 | ½ | 9/16 | ⅝ | 11/16 |
| 1¾ | ⅜ | 7/16 | ½ | 9/16 | ⅝ |
| 1 13/16 | 5/16 | ⅜ | 7/16 | ½ | 9/16 |
| 1⅞ | ¼ | 5/16 | ⅜ | 7/16 | ½ |
| 1 15/16 | 3/16 | ¼ | 5/16 | ⅜ | 7/16 |
| 2 | ⅛ | 3/16 | ¼ | 5/16 | ⅜ |

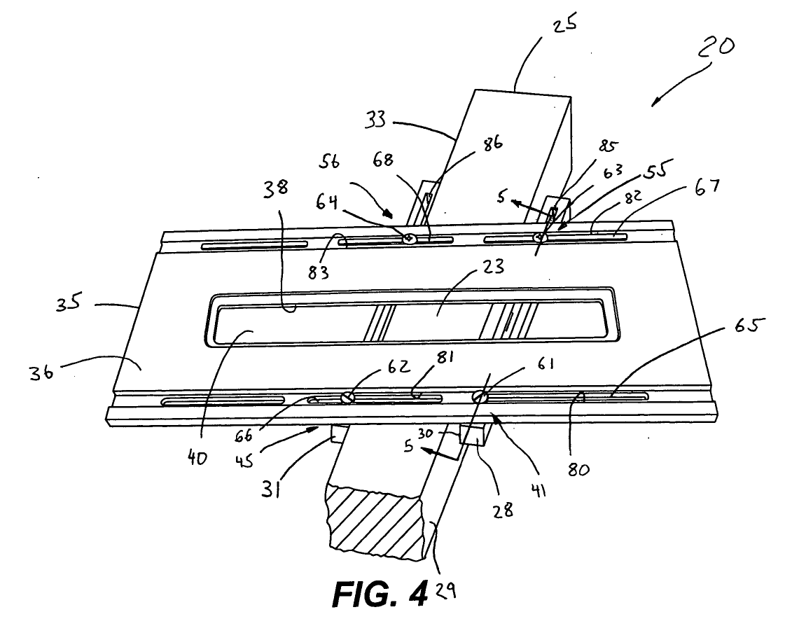

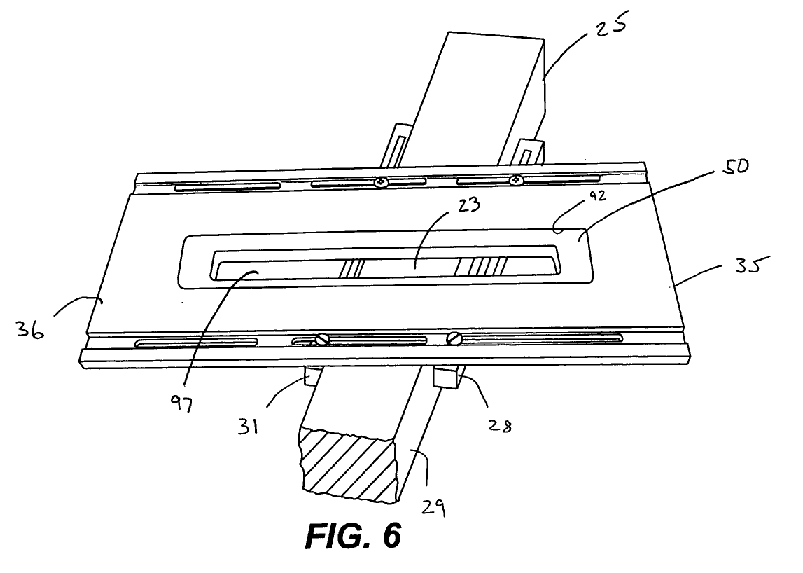

In the preferred form, the bit passage 40 is elongated, and rectangular shaped. As shown in FIG. 4, the bit passage extends generally from one side of the base member to the other side. As will be apparent, the length and width are adjustable, depending upon the desired length and width of the targeted cut shape. Moreover, as will be described, a template bushing insert 50 (FIG. 6) can be inserted into the bit passage that further defines the shape and/or size of the target cut. It will appreciated, however that the largest target cut will be determined by the contact walls 38 that define the bit passage 40 and that the cutting area dimension of the insert passage is smaller than that of the bit passage.

Briefly, during the cutting operation, the support plate 26 of the router 22 is held firmly and in sliding contact against tool support plate 26. This assures that the cutting bit 21 is square with the base member 35 to execute a precise and accurate cut. By moving the router bit around bit passage 40, via the sliding contact between the support plate 26 and the base member 35, the target cut will can be simply fabricated. Using the contact between the exterior surface of the support plate guide collar 27 and the contact walls 38 of the bit passage 40, the perimetric limits of the target cut will be defined. That is, as the guide collar 27 of the support plate 26 contact the contact walls 38 of the bit passage 40, further travel of the cutter bit into the workpiece will be limited in that direction.

In accordance with the present invention, the upper surface of the guide rails are preferably vertically displaced from the workpiece support surface 37 of the base member 35. In this manner, the router bit 21 is allowed to extend past the guide rails 28, 31 in the bit passage without contacting the abutting surfaces 30, 32 thereof. This arrangement is beneficial when plough cuts are required that extend from the first side of the workpiece to the opposite second side thereof. By vertically displacing the guide rails 28, 31 from the workpiece support surface 37 by a sufficient amount, the router bit may pass therethrough unobstructed. It will be appreciated, however, that the depth of the recess portion from the respective top surface of each guide rail must be sufficient to enable the passage of the router bit extending through the bit passage 40.

One technique to perform this off-set or displacement is to provide spacers 51-54 or shims at the interconnection assemblies (FIG. 5) that do not protrude into the path of the bit passage 40. These spacers should at least be in the range of about ¼ inch to about ¾ inch thick, but may be any reasonable depth. By changing the thickness of the spacers 51-54, different depth ploughs can be accommodated. Another technique to create sufficient space for the passage of the cutter bit through the bit passage 40 during a plough cut is to provide an upper recess directly in the upper surface of the guide rails. Essentially, in this configuration, the spacers would be integrally formed with the guide rails.

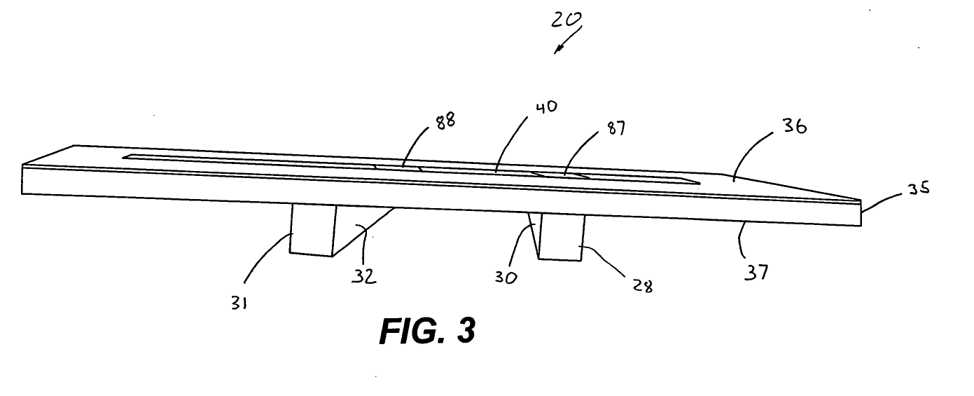

As set forth above, the opposed guide rails 28, 31 and their corresponding interconnection assembly 41, 45 cooperate to pivot the rails about the respective rotational axis 42, 46 of their corresponding interconnection assembly, relative the base member (FIG. 3) Additionally, the corresponding interconnection assemblies enable sliding displacement of the respective rail member along a corresponding path substantially adjacent to the bit passage. In this manner, the collective pivoting and sliding displacement of the interconnection assemblies enable size and shape accommodations by the guide rails for the workpiece.

To add further stability of the movement, mounting and positioning of the first guide rail to the base member, a third interconnection assembly 55 is provided This interconnection, however, is positioned along the base member on the other side of the bit passage 40, opposite that of the first interconnection assembly. Similarly, a fourth interconnection assembly 56 is provided that further mounts the second guide rail 31 to the base member 35. This interconnection is also positioned on the other side of the bit passage 40 and is opposite that of the second interconnection assembly 45.

Both the third interconnection assembly 55 and the fourth interconnection assembly 56 are also configured to releasably lock the first guide rail 28 to the base member 35, and the second guide rail 31 to the base member 35, respectively. The third interconnection assembly 55 enables the first guide rail 28 to pivot about a third axis 57 that is substantially parallel to the first axis 42 of the first interconnection assembly 41, and thus is similarly substantially perpendicular to the longitudinal axis 43 of the first guide rail 28. Similarly, the fourth interconnection assembly 56 enables the second guide rail 31 to pivot about a fourth axis 58 that is similarly substantially parallel to the second axis 46 of the second interconnection assembly 45, and is substantially perpendicular to the longitudinal axis 47 of the second guide rail. Further, both the third and fourth interconnection assemblies 55, 56 enable the respective end of the first guide rail 28 and that of the second guide rail 31 to slide along the base member 35, both along respective paths extending in a direction substantially adjacent to the bit passage 40.

Collectively, thus, the first and second guide rails 28, 31, together with the first through fourth interconnection assemblies 41, 45, 55 and 56 cooperate to seat the abutting surfaces 30, 32 of the guide rails 28, 31 firmly against the opposed sides 31, 33 of the workpiece 25. This can be performed even when the opposed sides 31, 33 of the workpiece are non-parallel and non-linear. Moreover, the interconnection assemblies enable the bit passage 40 of the base member 35 to be orient, relative the cutting surface of the workpiece, in effect rotating bit passage 40 about the cutting surface.

In accordance with the present invention, and as best viewed in FIGS. 2 and 5, each interconnection assembly includes an associated pin member 61-64 upon which the corresponding guide rail 28, 31 pivots about. It will be appreciated, of course, that the first pin member 61 and the third pin member 63 of the corresponding first and third interconnection assemblies 41, 55 work in conjunction with one another to move pivot the first guide rail 28 relative the bit passage 40 of the base member 35. Similarly, the second pin member 62 and the fourth pin member 64 of the corresponding second and fourth interconnection assemblies 45, 56 work in conjunction with one another to pivot the second guide rail 31 relative the bit passage 40 of the base member 35.

As mentioned, such pivotal motion is about axes substantially perpendicular to the corresponding longitudinal axis of the respective guide rail. Further, such joint pivotal movement is in a plane substantially parallel to a plane containing the bit passage 40.

To accommodate the sliding movement and motion of each interconnection assembly along associated paths, the base member includes associated receiving slots 65-68 extending in directions substantially adjacent the bit passage 40. These elongated receiving slots 65-68 extend through the base member 35 from the tool support surface 36 to the workpiece support surface 37, are formed and dimensioned for sliding receipt of the shafts of the corresponding pin members. In one embodiment, the receiving slots 65-68 are substantially linear, and extend substantially parallel to the longitudinal axis 69 of the bit passage. It will be appreciated, however, that the associated paths need not be linear or parallel to the bit passage, as long as they extend generally adjacent thereto.

Briefly, each fastening pin member 61-64 includes an associated, elongated shaft portion 70-73 and a head portion 75-78 coupled to the distal end thereof. The opposite ends of the pin members 61-63 can be threaded for receipt of a threaded nut or the like thereon. Similar to fastening screws, the transverse cross-section area of the head portion is larger than that of the corresponding elongated shaft. Accordingly, the width of the elongated receiving slots 65-68 are formed and dimensioned for sliding receipt of the respective shafts 70-73 of the pin members therealong, while being sufficiently small to prevent axial passage of the corresponding head portions therethrough.

To accommodate the head portions 75-78 of the pin members 61-64, however, they are recessed below the tool support surface so that they do not interfere with the sliding operation of the support plate 26 of the tool device 22 during operational use thereof. This is performed by providing an associated recessed portion 80-83 surrounding the receiving slots 65-68 from the tool support surface 36 of the base member. These recessed portions 80-83 are formed and dimensioned for sliding receipt of the head portions 75-78 of the pin members 61-64 to enable sliding movement thereof along the associated path. Moreover, the recessed portions 80-83 are sufficiently deep to enable positioning of the head portions 75-78 sufficiently below the tool support surface 36 to prevent interference during the cutting operation.

In accordance with the present invention, each guide rail 28, 31 includes at least one interconnection assembly that further provides sliding displacement movement of the selected pin member in a direction longitudinally along the longitudinal axis 43, 47 of the respective guide rail thereof. This sliding displacement of the at least one pin member in necessary since the corresponding interconnection assemblies (i.e., the first and third interconnection assemblies 41, 55 and the second and fourth interconnection assemblies 45, 56) are both mounted to the base member, and provide pivotal and sliding movement thereof. Accordingly, as each guide rail 28, 31 is repositioned, the respective linear displacement between the corresponding pin members 61, 63 and 62, 64 will vary.

Similar to the receiving slots 65-68 of the base member, each guide rail 28, 31 includes at least one elongated guide slot 85, 86 extending in a direction along the longitudinal axis 43, 47 thereof. Each guide slot 85, 86 is formed and dimensioned for sliding receipt of the associated shaft of the pin member 63, 64 therein. It will be appreciated that while only one elongated guide slot 85, 86 is shown and described for each guide rail to permit pivotal movement about the associated axis, and permit sliding movement along the associated path, an associated guide slot could be provided for each shaft of the pin members 61-64.

While each interconnection assembly has been shown and described as including a pin member, elongated slot and elongated guide slot to enable the aforementioned pivotal and sliding motion of the guide rail relative the base member, it will be appreciated that other conventional mechanisms could be employed that provide such movement characteristics. These include any pivot and slide mechanism or tracks.

In accordance with the present invention, the bit passage 40 is preferably rectangular shaped and extends from along its longitudinal axis 69 from one side of the base member 35 to the opposite side thereof. As further indicated, it is the contact wall 38 that perimetrically defines the shape of the bit passage 40, and provides the contact surface upon which the guide collar 27 of the router support plate 26 contacts during the cutting operations. In some instances, such as during mortise cuts, the ends of the target cut do not extend through the opposed first and second side walls 31, 33 of the workpiece 25. In this instance, end bushing inserts 87, 88 can be provided that limit to cut length in the bit passage 40 in directions along the longitudinal axis 69 thereof.

FIGS. 1 and 2 best illustrate that these end bushings are in the form of insert devices removably mounted in the bit passage 40 of the base member 35. By providing a barrier extending transversely across the bit passage, generally in a direction substantially perpendicular to that of the longitudinal axis 69 of the bit passage 40, the longitudinal length of the cut can be selectively controlled.

Each end bushing insert 87, 88 includes a substantially linear end contacting edge 90, 91 extending transversely across the bit passage. The respective contacting edges 90, 91 are shown extending substantially perpendicular to the longitudinal axis of the bit passage. It will be appreciated, however, that the end bushings can easily incorporate contacting edges that are slanted, relative the longitudinal axis 69, or that are curvilinear or angularly shaped.

To mount the end bushings securely to the base member 35, a central recess 92 is formed about the contact wall 38 of the bit passage 40, similar to the recessed portions 80-83 surrounding the elongated receiving slots 65-68. In this manner, a support shoulder 93 is formed on each side of the bit passage upon which the end bushings are slideably supported for movement in a direction along the longitudinal axis 69 of the bit passage 40. Accordingly, the end bushing inserts 87, 88 include opposed wing portions 95 that slideably seat against the support shoulder 93 for sliding support of the bushings. Moreover, the depth of the support shoulder 93 from the tool support surface is important so that the top surface of the end bushing will not interfere with the sliding support of the support plate 26 of the router 22 during the cutting process. Accordingly, the thickness of the wing portions 95 are sized and configured so that an upper surface of the end bushings lie substantially flush with the tool support surface when positioned therein.

Moreover, it is important that a bottom surface of the end bushing insert 87, 88 is similarly configured to be at least substantially flush with the bottom workpiece support surface 37 as well. This assures that the end bushings will not interfere with either the sliding operation of the router support plate 26 during operation, or the positioning and orientation of the workpiece 25 relative the bit passage 40, and/or the positioning of the guide rails 28, 31 along the bottom of the base member 35.

In accordance with the present invention, the end bushing inserts 87, 88 may be provided by two opposed, similarly shaped plate members that each slideably seat in central recesses of the tool support surface 36 and the workpiece support surface 37 that enable the opposed plate members to seat flush in the base member 35. Thus, each support surface provides a respective support ledge or wing portion that enables seating against the support shoulders of the base member.

To secure the end bushings to the base member, a fastening device 96 may be provided that cooperates with threaded holes in at least one of the two opposed plate members to urge them together against the support shoulders thereof. This may be provided by a countersunk screw or the like that is threaded through the plate members, and easily secures the two plate members together. By loosening the screw, each end bushing may be slideably positioned along the support shoulder 93 surrounding the bit passage.

In another aspect of the present invention, a template bushing insert 50 may also be provided that functions to alter the shape of the bit passage. As best viewed in FIG. 6, this bushing insert 50 can be placed and supported atop the support shoulders of the recessed portion in a manner similar to the end bushing inserts 87, 88. However, this template bushing insert 50 will provide an insert passage 97 of its own defined by an insert contact wall that may any shape or dimension that is smaller than the area dimension of the bit passage that it fits within. The template bushing insert 50 can be removably mounted to the opposed support shoulder in a manner similar to that of the end bushing inserts 87, 88.

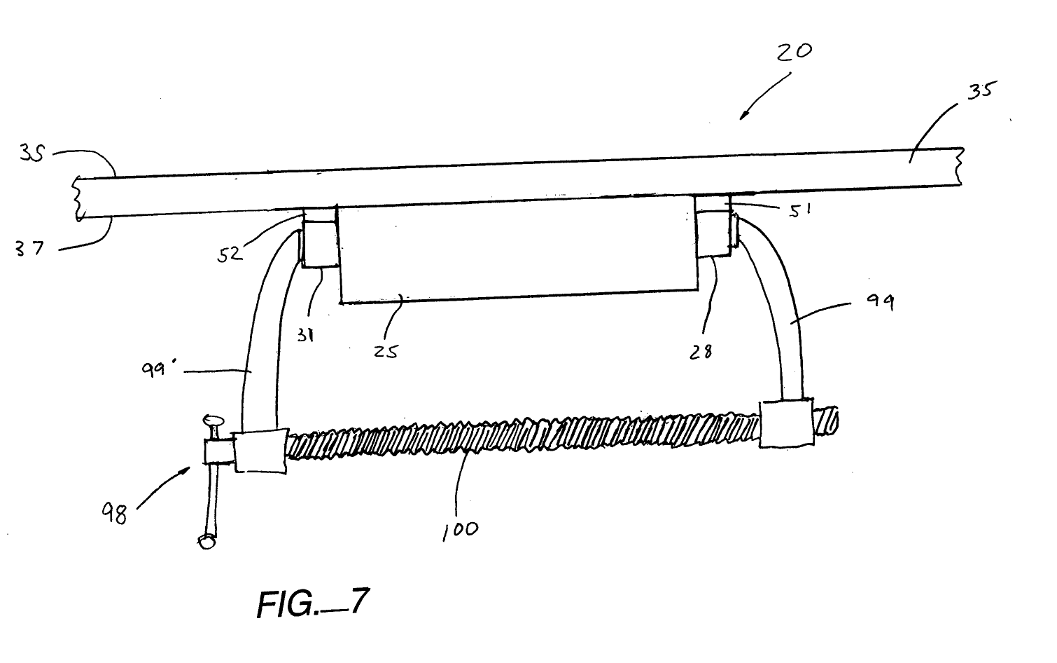

In order to removably secure the guide assembly 20 to the workpiece 25, conventional clamping devices can be provided that removably secure the guide rails 28, 31 to the workpiece. Briefly, FIGS. 7-13 illustrate several embodiments that function to removably secure the workpiece to the guide assembly. In one embodiment, shown in. FIG. 7, a conventional vise clamp 98 includes a pair of opposed jaws 99, 99′ that abut the sides of the guide rail 28, 31. By adjusting the threaded screw 100, the opposed jaws 99, 99′ can be tightened or loosened against the rails, which in turn is tighten or loosened against the workpiece 25.

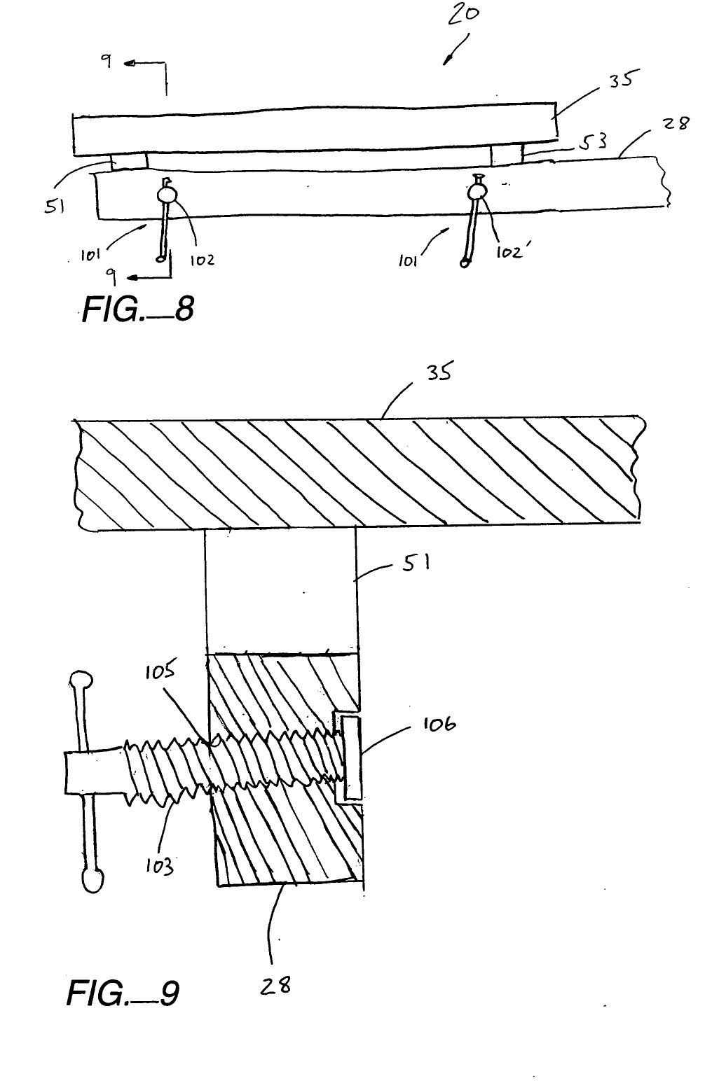

In another specific embodiment shown in FIGS. 8 and 9, a clamping device 101 is integrally formed with the guide assembly 20. In particular, a pair of spaced apart clamp members 102, 102′ are movably mounted to one of the guide rails. As shown in FIG. 9, the clamp members include a respective threaded bolt 103 that is threaded into a threaded aperture 105 extending through one of the guide rails (guide rail 28 for example). A gripping pad 106 at the distal end of the threaded bolt 103 seats against the workpiece (not shown), and urges the workpiece against the opposed guide rail 31.

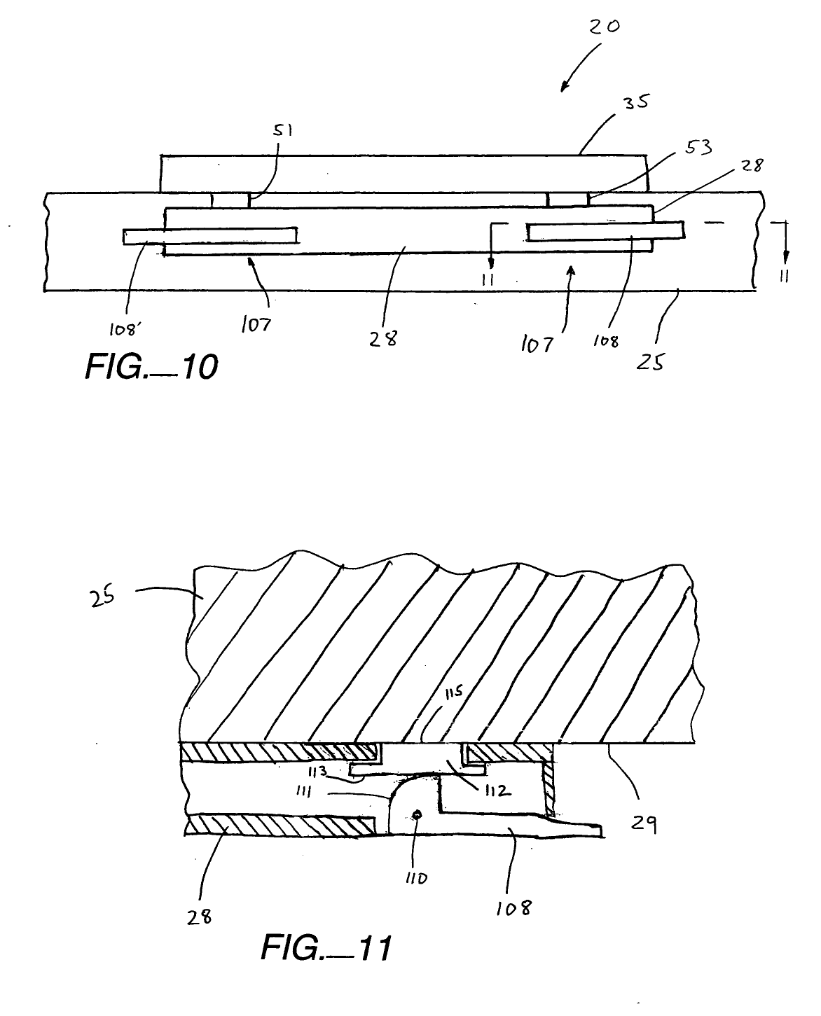

In yet another specific embodiment, as viewed in FIGS. 10 and 11, a cam-style clamping device 107 is provided that is also integrally formed with one of the guide rails 28, 31 of the guide assembly 20. A manually movable lever 108, 108′ is provided that is rotatably mounted to the guide rail (guide rail 28 in this example). The lever 108 is rotated about hinge 110 that moves a cam surface 111 of the lever into cammed contact with a gripping pad 112 movably mounted to the guide rail 28. As the cam surface 111 increasingly contacts the backside 113 of the gripping pad 112, the frontside 115 thereof increasingly contacts the side wall 29 of the workpiece 25 (as shown in FIG. 11). In turn, the workpiece 25 is tighten against the opposed guide rail 31.

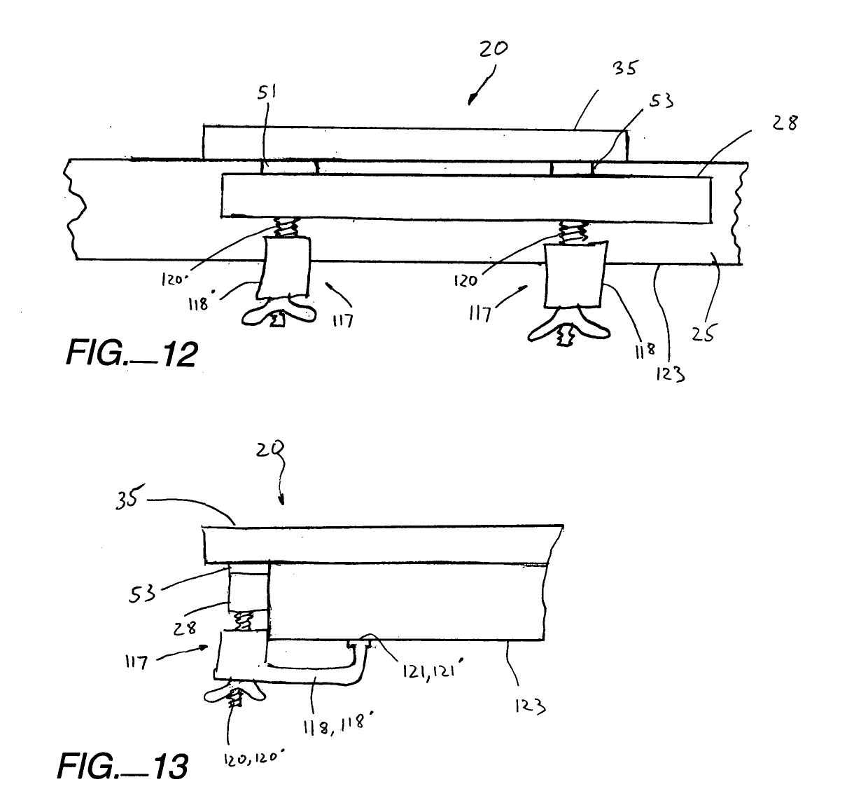

In still another clamp configuration (FIGS. 12 and 13), a vise-style clamp device 117 is shown that secures the workpiece 25 to the bottom side of the template plate 35. This clamp device 117 includes a pair of jaws 118, 118′ that are mounted to threaded bolts 120, 120′, respectively. As the threaded nut is manipulated, a pad 121, 121′ of the respective jaw 118, 118′ is urged into contact with a bottom side 123 of the workpiece. In turn, the workpiece 25 in urged into secured contact against the bottom side of the template plate 35. It will be appreciated that in this embodiment, the opposed guide rail 31 may include a similar clamp device.

Although only a few embodiments of the present inventions have been described in detail, it should be understood that the present inventions may be embodied in many other specific forms without departing from the spirit or scope of the inventions.

1. An adjustable guide assembly to guide a cutter bit of a tool device about a cutting surface of a workpiece, said tool device including a support plate providing a guide collar upon which the cutter bit extends therethrough, said guide assembly comprising:
a base member having a tool support surface and a workpiece support surface, and including a contacting wall defining an elongated bit passage extending along the base member, and extending therethrough from the tool support surface to the workpiece support surface; and
an elongated first guide rail having a first abutting surface adapted to abut a first side wall of the workpiece, said first guide rail being pivotally mounted to the base member at one end portion of the first guide rail for pivotal movement relative the base member, and further being slideably mounted to the base member in a manner enabling said first guide rail to slide along said base member adjacent to said bit passage;
wherein, said first guide rail is adjusted to abut the workpiece first side wall in a manner releasably positioning a targeted cutting region of the workpiece cutting surface in the bit passage for cutting of the targeted cutting region by the tool device cutter bit.

2. The adjustable guide assembly according to claim 1, further including:
an elongated second guide rail spaced-apart from said first guide rail, and having a second abutting surface adapted to abut a second side wall of the workpiece, said second side wall being opposed to the workpiece first side wall, and said second guide rail being pivotally mounted to the base member at one end portion of the second guide rail for pivotal movement relative the base member, and further being slideably mounted to the base member in a manner enabling said second guide rail to slide along said base member adjacent to said bit passage;
wherein, said first guide rail and said second guide rail are adjusted to abut the workpiece first side wall and the workpiece second side wall in a manner releasably positioning a targeted cutting region of the workpiece cutting surface in the bit passage for cutting of the targeted cutting region by the tool device cutter bit.

3. The adjustable guide assembly according to claim 2, further including:
a first interconnection assembly configured to releasably lock the first guide rail to said base member in a manner enabling the first guide rail to pivot about a first axis substantially perpendicular to a longitudinal axis of said first guide rail, said first interconnection assembly further enabling said first guide rail to slide along said base member adjacent to said bit passage; and
a second interconnection assembly configured to releasably lock the second guide rail to said base member in a manner enabling the second guide rail to pivot about a second axis substantially perpendicular to a longitudinal axis of said second guide rail, said second interconnection assembly further enabling said second guide rail to slide along said base member adjacent to said bit passage.

4. The adjustable guide assembly according to claim 2, wherein
said tool support surface is substantially planar, and adapted to slideably support the guide plate during the cutting operation.

5. The adjustable guide assembly according to claim 3, wherein
said first interconnection assembly includes an elongated first receiving slot extending adjacent said bit passage, and a fastening first pin member configured to releasably lock the first guide rail to said base member, and adapted to extend through said first receiving slot of the base member to enable said pivotal movement of the first guide rail about the first axis thereof, and the relative sliding movement adjacent said bit passage.

6. The adjustable guide assembly according to claim 5, wherein
said second interconnection assembly includes an elongated second receiving slot extending adjacent said bit passage, and a fastening second pin member configured to releasably lock the second guide rail to said base member, and adapted to extend through said second receiving slot of the base member to enable said pivotal movement of the second guide rail about the second axis thereof, and the relative sliding movement adjacent said bit passage.

7. The adjustable guide assembly according to claim 6, wherein
said first guide rail further defining a first elongated guide slot extending in a direction along said longitudinal axis to enable positioning of the first pin member, relative of the first guide rail, at one of a plurality of positioned longitudinally therealong, and
said second guide rail further defining a second elongated guide slot extending in a direction along said longitudinal axis to enable positioning of the second pin member, relative of the second guide rail, at one of a plurality of positioned longitudinally therealong.

8. The adjustable guide assembly according to claim 7, wherein
said first pin member and said second pin member are each selectively engagable between a lock condition, locking the respective guide rail relative to the base member, and a release condition, enabling movement of the respective guide rail relative to the base member.

9. The adjustable guide assembly according to claim 8, wherein
each of the first pin member and the second pin member includes a respective shaft portion formed and dimensioned for sliding receipt along the first receiving slot and the second receiving slot, respectively, and each the first pin member and the second pin member including a respective head portion having a transverse cross-sectional dimension preventing axial passage through the respective passage thereof.

10. The adjustable guide assembly according to claim 9, wherein
said tool support surface defining a first recess portion surrounding the first receiving slot, and formed for sliding receipt of the respective head portion along the associated path such that the respective head portion is flush with or below the tool support surface, and
said tool support surface further defining a second recess portion surrounding the second receiving slot, and formed for sliding receipt of the respective head portion along the associated path such that the respective head portion is flush with or below the tool support surface.

11. The adjustable guide assembly according to claim 6, wherein
each of the first pin member and the second pin member includes a respective shaft portion formed and dimensioned for sliding receipt along the first receiving slot and the second receiving slot, respectively, and each the first pin member and the second pin member including a respective head portion having a transverse cross-sectional dimension preventing axial passage through the respective passage thereof.

12. The adjustable guide assembly according to claim 11, wherein
said tool support surface defining a first recess portion surrounding the first receiving slot, and formed for sliding receipt of the respective head portion along the associated path such that the respective head portion is flush with or below the tool support surface, and
said tool support surface further defining a second recess portion surrounding the second receiving slot, and formed for sliding receipt of the respective head portion along the second receiving slot such that the respective head portion is flush with or below the tool support surface.

13. The adjustable guide assembly according to claim 1, wherein
said bit passage is elongated extending generally from one side of said base member to an opposite side thereof.

14. The adjustable guide assembly according to claim 13, wherein
said bit passage is substantially rectangular-shaped.

15. The adjustable guide assembly according to claim 13, further including:
a first end bushing adapted for selective positioning in said bit passage and configured to limit movement of the cutter bit of the tool device in one direction longitudinally along the bit passage during the cutting operation.

16. The adjustable guide assembly according to claim 15, wherein
said first end bushing is adapted for sliding movement longitudinally along the bit passage.

17. The adjustable guide assembly according to claim 16, wherein
said tool support surface defining an upper support shoulder extending substantially longitudinally along one side of the bit passage, and a lower support shoulder extending substantially longitudinally along an opposite side of the bit passage, and
said first end bushing including a pair of opposed wing portions formed and dimensioned for sliding guided receipt along the upper support shoulder and the lower support shoulder.

18. The adjustable guide assembly according to claim 15, further including:
a second end bushing adapted for selective positioning in said bit passage and configured to limit movement of the cutter bit of the tool device in an opposite direction longitudinally along the bit passage during the cutting operation.

19. The adjustable guide assembly according to claim 18, wherein
each said first end bushing and said second end bushing is adapted for sliding movement longitudinally along the bit passage.

20. The adjustable guide assembly according to claim 19, wherein
said tool support surface defining an upper support shoulder extending substantially longitudinally along one side of the bit passage, and a lower support shoulder extending substantially longitudinally along an opposite side of the bit passage, and
each said first end bushing and said second end bushing including a pair of opposed wing portions formed and dimensioned for sliding guided receipt along the upper support shoulder and the lower support shoulder.

21. The adjustable guide assembly according to claim 2, further including:
a plurality of clamp devices cooperating with a respective guide rail and the workpiece to releasably clamp the base member to the workpiece for operational cutting.

22. The adjustable guide assembly according to claim 3, further including:
a third interconnection assembly configured to releasably lock the first guide rail to said base member, at a location on an opposite side of said bit passage from said first interconnection assembly, in a manner enabling the first guide rail to pivot about a third axis substantially perpendicular to a longitudinal axis of said first guide rail, said third interconnection assembly further enabling said first guide rail to slide along said base member adjacent to said bit passage; and
a fourth interconnection assembly configured to releasably lock the second guide rail to said base member, at a location on an opposite side of said bit passage from said second interconnection assembly, in a manner enabling the second guide rail to pivot about a fourth axis substantially perpendicular to a longitudinal axis of said second guide rail, said fourth interconnection assembly further enabling said second guide rail to slide along said.

23. The adjustable guide assembly according to claim 22, wherein
said first interconnection assembly includes an elongated first receiving slot extending adjacent said bit passage, and a fastening first pin member configured to releasably lock the first guide rail to said base member, and adapted to extend through said first receiving slot of the base member to enable said pivotal movement of the first guide rail about the first axis thereof, and the relative sliding movement adjacent said bit passage,
said third interconnection assembly includes an elongated third passage extending adjacent said bit passage, on an opposite side thereof of the first receiving slot, and a fastening third pin member configured to releasably lock the first guide rail to said base member, and adapted to extend through said third passage of the base member to enable said pivotal movement of the first guide rail about the third axis thereof, and the relative sliding movement adjacent said bit passage,
said second interconnection assembly includes an elongated second receiving slot extending adjacent said bit passage, and a fastening second pin member configured to releasably lock the second guide rail to said base member, and adapted to extend through said second receiving slot of the base member to enable said pivotal movement of the second guide rail about the second axis thereof, and the relative sliding movement adjacent said bit passage, and
said fourth interconnection assembly includes an elongated fourth passage extending adjacent said bit passage, on an opposite side thereof of the second receiving slot, and a fastening fourth pin member configured to releasably lock the second guide rail to said base member, and adapted to extend through said fourth passage of the base member to enable said pivotal movement of the second guide rail about the fourth axis thereof, and the relative sliding movement adjacent said bit passage.

24. The adjustable guide assembly according to claim 23, wherein
said first guide rail further defining a first elongated guide slot and a third guide slot each extending in a direction along said longitudinal axis to enable positioning of the first pin member and the third pin member, respectively, relative of the first guide rail, at one of a plurality of positioned longitudinally therealong, and
said second guide rail further defining a second elongated guide slot and a fourth guide slot each extending in a direction along said longitudinal axis to enable positioning of the second pin member and the fourth pin member, respectively, relative of the second guide rail, at one of a plurality of positioned longitudinally therealong.

25. The adjustable guide assembly according to claim 23, further including:
a bushing insert device defining an insert passage therethrough, and configured for positioning in said bit passage.

26. An adjustable guide assembly to guide a cutter bit of a tool device about a cutting surface of a workpiece, said tool device including a support plate providing a guide collar upon which the cutter bit extends therethrough, said guide assembly comprising:
an elongated first guide rail having a first abutting surface adapted to abut a first side wall of the workpiece, said first guide rail defining a elongated first guide slot extending in a direction along the first abutting surface of said first guide rail;
a second guide rail spaced-apart from said first guide rail, and having a second abutting surface adapted to abut a second side wall of the workpiece, said second side wall being opposed to the workpiece first side wall, said second guide rail defining a elongated second guide slot extending in a direction along the second abutting surface of said second guide rail;
a base member positioned over the first and second guide rails, and having a tool support surface and a workpiece support surface, and said base member including a contacting wall defining a bit passage therethrough from said tool support surface to the workpiece support surface, said base member further defining a first elongated passage extending adjacent said bit passage, and a second elongated passage extending adjacent said bit passage;
a fastening first pin member configured to releasably lock the first guide rail to said base member, and adapted to extend through said first receiving slot of the base member and through said elongated first guide slot of the first guide rail to enable the first guide rail to pivot relative to and slide adjacent said bit passage;
a second fastening pin member configured to releasably lock the second guide rail to said base member, and adapted to extend through said second receiving slot of the base member and through said second guide slot of the second guide rail to enable the second guide rail to pivot relative to and slide adjacent said bit passage;
wherein said first second guide rail and said second guide rail are adjusted to abut the workpiece first side wall and the workpiece second side wall, respectively, in a manner releasably positioning a targeted cutting region of the workpiece cutting surface across the bit passage.

27. The adjustable guide assembly according to claim 26, wherein
said tool support surface is substantially planar, and adapted to slideably support the guide plate during the cutting operation.

28. The adjustable guide assembly according to claim 27, wherein
said first guide rail further defining a first elongated guide slot extending in a direction along said longitudinal axis to enable positioning of the first pin member, relative of the first guide rail, at one of a plurality of positioned longitudinally therealong, and
said second guide rail further defining a second elongated guide slot extending in a direction along said longitudinal axis to enable positioning of the second pin member, relative of the second guide rail, at one of a plurality of positioned longitudinally therealong.

29. The adjustable guide assembly according to claim 26, wherein
said first pin member and said second pin member are each selectively engagable between a lock condition, locking the respective guide rail relative to the base member, and a release condition, enabling movement of the respective guide rail relative to the base member.

30. The adjustable guide assembly according to claim 29, wherein
each of the first pin member and the second pin member includes a respective shaft portion formed and dimensioned for sliding receipt along the first receiving slot and the second receiving slot, respectively, and each the first pin member and the second pin member including a respective head portion having a transverse cross-sectional dimension preventing axial passage through the respective passage thereof.

31. The adjustable guide assembly according to claim 29, wherein
said tool support surface defining a first recess portion surrounding the first receiving slot, and formed for sliding receipt of the respective head portion along the first receiving slot such that the respective head portion is flush with or below the tool support surface, and
said tool support surface further defining a second recess portion surrounding the second receiving slot, and formed for sliding receipt of the respective head portion along the associated path such that the respective head portion is flush with or below the tool support surface.

32. The adjustable guide assembly according to claim 26, wherein
said bit passage is elongated extending generally from one side of said base member to an opposite side thereof.

33. The adjustable guide assembly according to claim 32, wherein
said bit passage is substantially rectangular-shaped.

34. The adjustable guide assembly according to claim 32, further including:
a first end bushing adapted for selective positioning in said bit passage and configured to limit movement of the cutter bit of the tool device in one direction longitudinally along the bit passage during the cutting operation, and
a second end bushing adapted for selective positioning in said bit passage and configured to limit movement of the cutter bit of the tool device in an opposite direction longitudinally along the bit passage during the cutting operation.

35. The adjustable guide assembly according to claim 18, wherein
each said first end bushing and said second end bushing is adapted for sliding movement longitudinally along the bit passage.

36. The adjustable guide assembly according to claim 35, wherein
said tool support surface defining an upper support shoulder extending substantially longitudinally along one side of the bit passage, and a lower support shoulder extending substantially longitudinally along an opposite side of the bit passage, and
each said first end bushing and said second end bushing including a pair of opposed wing portions formed and dimensioned for sliding guided receipt along the upper support shoulder and the lower support shoulder.
